(19) United States
(12) Patent Application Publication
(10) Pub. No.: US 2025/0165316 A1
(43) Pub. Date: May 22, 2025

(54) SMOOTHING PERIODIC DATA CHANNEL ACCESS

(71) Applicant: ColdQuanta, Inc., Boulder, CO (US)

(72) Inventors: Timothy Burton Lewis, Lafayette, CO (US); Jonathan James Mason, Madison, WI (US)

(73) Assignee: ColdQuanta, Inc., Boulder, CO (US)

(21) Appl. No.: 18/948,731

(22) Filed: Nov. 15, 2024

Related U.S. Application Data
(60) Provisional application No. 63/599,895, filed on Nov. 16, 2023.

(51) Int. Cl. G06F 9/54; G06F 9/48

(52) U.S. Cl. CPC G06F 9/542; G06F 9/4887; G06F 2209/543

(57) ABSTRACT

In one aspect, a system comprises: a memory configured to store a plurality of data units; a plurality of data sources, where each data source is configured to provide a respective data unit; and a processor configured to: determine a plurality of periods where each period is associated with a respective event and each event is associated with a different respective data source, determine a plurality of adjusted periods, where each period is associated with a respective adjusted period, determine a respective order for each adjusted period, determine a number of adjusted periods associated with each order, determine a number of time slots for a lowest order of adjusted periods based on the number of adjusted periods within each of the orders, and determine a start time for each event based on the order of the event and the number of time slots for the lowest order of adjusted periods.

### CROSS-REFERENCE TO RELATED APPLICATION(S)

This application claims priority to and the benefit of U.S. Provisional Application Ser. No. 63/599,895, entitled “SMOOTHING PERIODIC DATA CHANNEL ACCESS,” filed Nov. 16, 2023, the entire disclosure of which is hereby incorporated by reference.

### TECHNICAL FIELD

This disclosure relates to smoothing periodic data channel access.

### BACKGROUND

Embedded systems can have reduced capabilities compared to non-embedded systems. For example, embedded systems can have less powerful processors or less memory. In addition, embedded systems can have real-time processing requirements. Having less powerful processors and less memory can make successfully handling the real-time processing requirements more challenging.

Embedded systems can also comprise numerous components. These components may produce data that is consumed by a program running on the embedded processor. Components may generate data on a schedule. Accessing data by the embedded processor can result in bottlenecks or peaks of usage in terms of process utilization, memory utilization or both. Avoiding these usage peaks can be beneficial for embedded systems, especially due to the limited available resources. Removing such peaks can be beneficial to any computing system that consumes data.

### SUMMARY

In one aspect, in general, a system comprises: a memory configured to store a plurality of data units; a plurality of data sources, where each data source is configured to provide a respective data unit; and a processor configured to: determine a plurality of periods where each period of the plurality of periods is associated with a respective event and each event is associated with a different respective data source of the plurality of data sources providing a data unit, determine a plurality of adjusted periods, where each period of the plurality of periods is associated with a respective adjusted period of the plurality of adjusted periods, determine a respective order for each adjusted period of the plurality of adjusted periods, determine a number of adjusted periods associated with each of the orders, determine a number of time slots for a lowest order of adjusted periods based on the number of adjusted periods within each of the orders, and determine a start time for each event based on the order of the event and the number of time slots for the lowest order of adjusted periods.

Aspects can include one or more of the following features.

To determine the plurality of adjusted periods the processor is further configured to: determine the minimum period of the plurality of periods as pₘᵢₙ, and for each period of the plurality of periods calculate the corresponding adjusted period as pₘᵢₙ*2^{(floor(log} ^{₂}^{(period/p}^{ₘᵢₙ}⁾⁾⁾.

To determine the respective order for each adjusted period of the plurality of adjusted periods the processor is further configured to: sort the plurality of adjusted periods, and assign a unique order for each adjusted period of a same value, such that the plurality of adjusted periods have a highest order.

To determine the number of time slots for the lowest order of adjusted periods the processor is further configured to calculate a summation

$$⌈ {\sum }_{i} \frac{{n}_{i}}{{2}^{i}} ⌉ ,$$

where i is equal to the order, and nᵢ is equal to a number of events in the order.

To determine the number of time slots for the lowest order of adjusted periods the processor is further configured to: determine a number of time slots for the highest order of adjusted periods as the number of adjusted periods in the highest order, and for each remaining order, determine a number of time slots for a current order as the number of adjusted periods in the current order plus a ceiling of the number of time slots of an immediately previous order divided by two, wherein the number of time slots is equal to the number of time slots for the lowest order.

To determine the start time for each event based on the order of the event the processor is further configured to: calculate pₘᵢₙ/(the number of time slots) to create time slots of the lowest order, and assign each event associated with the lowest order of adjusted periods to one of the time slots of the lowest order as the start time.

To determine the start time for each event based on the order of the event the processor is further configured to: for each remaining time slots of the lowest order, add pₘᵢₙ*2⁽ⁱ⁻¹⁾ to create time slots of a next order, where i is the order, and assign each event associated with adjusted periods of the next order to one of the time slots of the next order as the start time.

To determine the start time for each event based on the order of the event, the processor is further configured to either add an adjustment factor to or subtract an adjustment factor from least one start time.

The adjustment factor is within the range of plus or minus: pₘᵢₙ/(the number of time slots for the lowest order of adjusted periods).

The adjustment factor is based at least in part on a completion time associated with an event.

The system further comprises: a first component associated with a data unit provided by a first data source of the plurality of data sources; and a second component configured to be controlled by the processor; wherein the processor is further configured to: access the data unit of the first component at the determined start time, and control the second component based on the accessed data unit of the first component.

To determine the number of time slots for the lowest order of adjusted periods the processor is further configured to calculate

$$⌈ {\sum }_{i} \frac{{n}_{i}}{{2}^{i}} ⌉ ,$$

where i is equal to the order, and nᵢ is equal to a number of events in the order.

Each event is associated with the processor accessing a respective data unit.

The processor accesses the data unit at the start time associated with the event or at a time that is the sum of the start time and an integer multiple of the adjusted period associated with the event.

The system further comprises a first component configured to be controlled by the processor; wherein a first data source of the plurality of data sources is configured to provide a data unit for each event of a plurality of events and the processor is configured to control the first component based at least in part on each data unit.

A first event of the plurality of events is the determined start time and each subsequent event of the plurality of events is a sum of the determined start time and an integer multiple of an associated adjusted period.

In another aspect, in general, a method for scheduling event start times for a system comprising a plurality of data sources, where each data source of the plurality of data sources is configured to provide a respective data unit, comprises: determining a plurality of periods, where each period of the plurality of periods is associated with a respective event and each event is associated with a respective data unit of a data source; determining a plurality of adjusted periods, wherein each period of the plurality of periods is associated with a respective adjusted period of the plurality of adjusted periods; determining a respective order for each adjusted period of the plurality of adjusted periods; determining a respective number of adjusted periods associated with each order; determining a number of time slots for a lowest order of adjusted periods based at least in part on the respective number of adjusted periods within each order; and determining an event start time for each event based at least in part on (1) the order of the event and (2) the number of time slots for the lowest order of adjusted periods.

Aspects can have one or more of the following advantages.

In some implementations, a system can be associated with a set of one or more events. In some examples, a schedule associated with the set of one or more events can be created. In some examples, this schedule can be associated with optimizing process utilization or memory utilization of a processor of the system.

In some implementations, creating a schedule of events for a system can be associated with efficient use of resources such as memory.

Other features and advantages will become apparent from the following description, and from the figures and claims.

### BRIEF DESCRIPTION OF THE DRAWINGS

The disclosure is best understood from the following detailed description when read in conjunction with the accompanying drawing. It is emphasized that, according to common practice, the various features of the drawing are not to-scale. On the contrary, the dimensions of the various features are arbitrarily expanded or reduced for clarity.

FIG. 1 is a schematic diagram of an example schedule associated with a system.

FIG. 2 is a schematic diagram of an example schedule associated with a system.

FIG. 3 is a schematic diagram of an example system.

FIG. 4 is a schematic diagram of an example flowchart to determine a schedule.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more examples of the invention is provided below along with accompanying figures that illustrate various features of the invention. The invention is described in connection with such examples, but the invention is not limited to any example. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some systems can be associated with a plurality of events that can each have an associated period such that the system is associated with a plurality of periods p₀, p₁, p₂, . . . , pₙ. In one specific example, a schedule for a system can be determined by taking the smallest period pₘᵢₙ=min(p₀, p₁, p₂, . . . , pₙ) and creating x evenly spaced “time slots” between time 0 and pₘᵢₙ that can then occur every pₘᵢₙ duration. This spacing can allow for each event to occur within pₘᵢₙ/x of another event. The length of each time slot is xₜₛ=pₘᵢₙ/x.

It will thus be seen that the objects set forth above, among those made apparent from the preceding description, can be efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

In an example, the periods for each event can be adjusted down to the nearest power of two times pₘᵢₙ. In some examples, the adjusted periods can be written using the notation p′. For example, p′=(p′₀, p′₁, p′₂, . . . , p′ₙ) where p′ₙ=pₘᵢₙ*2^{└log}^{₂}^{(p}^{ₙ}^{/p}^{ₘᵢₙ}^{)┘}. As a specific example, if p₀=121.3*pₘᵢₙ then p′₀=64*pₘᵢₙ. In some implementations, events can be grouped into one or more sets of events, where each set of events is associated with an order. The set of events where p′ₙ*2^{k} may be referred to as the kth order.

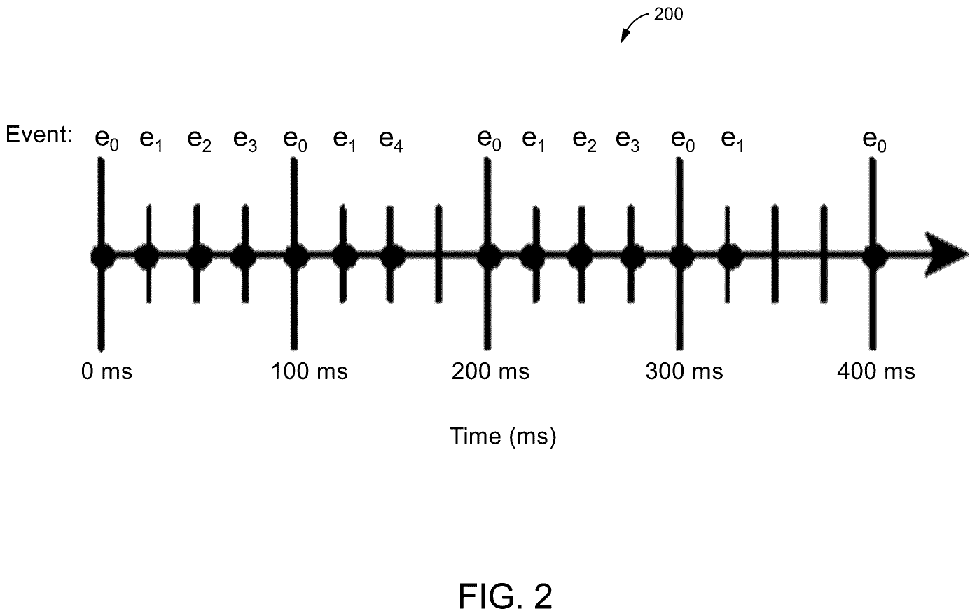

Events with adjusted periods that are multiples of pₘᵢₙ can share a time slot with other events. In some examples, collision between events can be avoided because each event sharing a time slot can use every 2nd, 4th, 8th, etc. slot. This sharing can be seen in FIG. 2, where the time slots for larger order events becomes large enough to overlap with other events that have smaller time slots.

As a specific example, assume a system is associated with a set of events (e₀, e₁, e₂, e₃, e₄, e₅). The periods (p₀, p₁, p₂, p₃, p₄, p₅) of the events are (100, 100, 150,300, 375, 600), respectively. The time units for the periods can be any time unit, such as but not limited to, nanoseconds, milliseconds, centiseconds, seconds, minutes, etc. As the units do not impact the determination of the schedule, the units are dropped for simplicity.

For this specific example, pₘᵢₙ=100. To determine the order of each event, the adjusted time periods p′ₙ can be calculated, as shown in table 1.

As pₘᵢₙ is divided into x number of time slots, the value of x can be determined. The value of x can depend on the number of events as well as the period of those events. In one example, the number of time slots can be determined by starting with the highest order and working down to the 0th order. In this example, each step can be viewed as computing the number of time slots that would be necessary if that the smallest order. For the largest order, the number of time slots xᵢ is the number of events nᵢ in that order. Then, for each subsequent iₜₕ order, the number of time slots xᵢ can be calculated from xᵢ=nᵢ+┌xᵢ₊₁/2┐, where nᵢ is the number of events in the order.

TABLE 1
Table of events with associated periods,
adjusted periods, and orders.

| Event | Period | p′ Calc. | p′ | Order |
|---|---|---|---|---|
| e₀ | 100 | p′₀ = 100*2^{└log}^{₂}^{(100/100)┘} | 100 | 0 |
| e₁ | 100 | p′₁ = 100*2^{└log}^{₂}^{(100/100)┘} | 100 | 0 |
| e₂ | 150 | p′₂ = 100*2^{└log}^{₂}^{(150/100)┘} | 100 | 0 |
| e₃ | 300 | p′₃ = 100*2^{└log}^{₂}^{(300/100)┘} | 200 | 1 |
| e₄ | 375 | p′₄ = 100*2^{└log}^{₂}^{(375/100)┘} | 200 | 1 |
| e₅ | 600 | p′₅ = 100*2^{└log}^{₂}^{(600/100)┘} | 400 | 2 |

Continuing the specific example from above, the number of time slots is 5. The specific calculations are shown in table 2

TABLE 2
Table of example calculations associated with
determining time slots for each order.

| Order | Calc | Num of Time Slots (xᵢ) |
|---|---|---|
| 2 | x₂ = n₂ = 1 | 1 |
| 1 | x₁ = 2 + ┌1/2┐ | 3 |
| 0 | x₀ = 3 + ┌3/2┐ | 5 |

In another example, the number of time slots may be calculated as:

$$⌈ {\sum }_{i} \frac{{n}_{i}}{{2}^{i}} ⌉ .$$

Using this example, the number of time slots for the current example can be calculated as 5. The specific calculations are shown in table 3. As the sum in this example equals 4.25, the ceiling of this value is 5.

Now that the number of time slots has been calculated, the start time for each event can be determined. To start, the time slots for the lowest order of events are calculated as 0, pₘᵢₙ/x₀, 2*pₘᵢₙ/x₀, . . . , (x₀−1)*pₘᵢₙ/x₀. Continuing the specific example from above that has pₘᵢₙ=100, the time slots for the lowest order of events would be 0, 20, 40, 60, 80.

TABLE 3
Table of example calculations associated with determining
a number of time slots for each order.

| Order | nᵢ/2ⁱ | ${\sum }_{i} \frac{{n}_{i}}{{2}^{i}}$ |
|---|---|---|
| 0 | 3/1 | 3 |
| 1 | 2/2 | 4 |
| 2 | ¼ | 4.25 |

Once the time slots have been determined, the events in order 0 may be assigned to a specific time slot starting at time 0. In the above example, events e₀, e₁, and e₂ would be assigned to time slots 0, 20, 40, respectively.

The remaining time slots, 60 and 80, can be used to determine where events in the next order, e.g., 1, can start. Each of the remaining time slots can be used to create a new time slot. In this example, the number of time slots is doubled. In one example, the new time slots can be calculated by adding pₘᵢₙ*2ⁱ⁻¹ to each time slot. With i=1 the time added is simply pₘᵢₙ. Accordingly for this example, the new time slots become 60, 80, 160, and 180.

Once the new time slots are determined, events in the current order can be assigned to time slots. For example, e₃ and e₄ can be assigned to time slots 60 and 80 respectively. In one example, the remaining 160 and 180 time slots are used to calculate additional time slots for order 2 events. The amount of time to add to each time slot's starting point is pₘᵢₙ*2²⁻¹=200. The available time slots for order 2 events, therefore, become 160, 180, 360, and 380. The only event e₅ in order 2 may then be assigned to start at time 160.

In other examples, as the number of events to assign is less than the number of available time slots, the calculations of new time slots can be skipped. In still other examples, whenever the number of unassigned events is less than or equal to the number of free time slots, the calculations for determining additional time slots can be avoided. For example, continuing the example from above, the time slot 180 was calculated in association with the three time slots 60, 80, and 160. However, because the example system only had three unassigned events (2 events from order 1 and 1 event from order 2), the calculation determining 180 could be skipped to save computation.

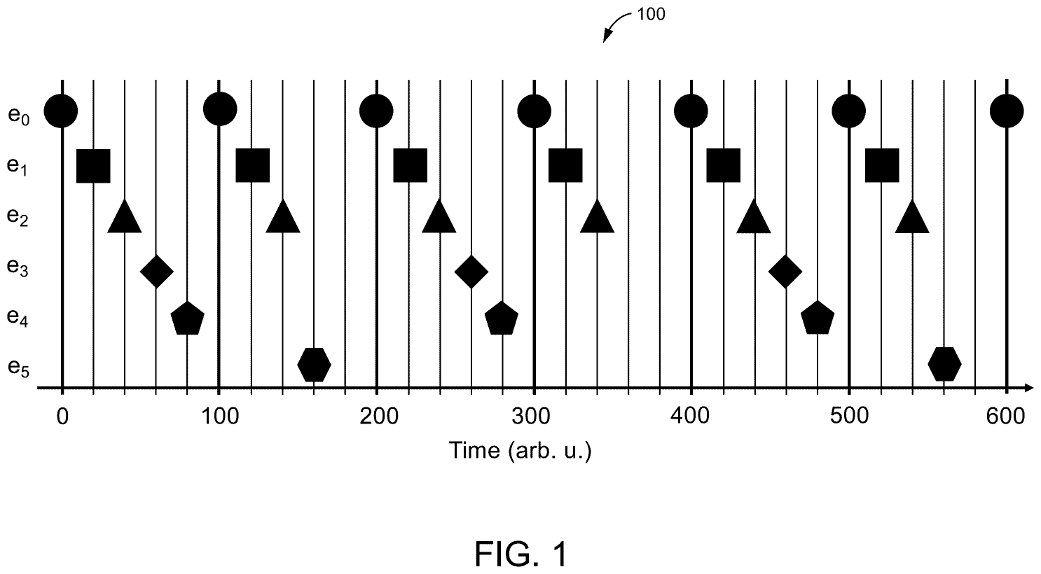

FIG. 1 depicts an example schedule 100 associated with the set of events (e₀, e₁, e₂, e₃, e₄, e₅) between time units 0 and 600. Each event is represented as a different respective shape. As shown by the schedule 100, a first instance of the event e₀ occurs at time 0, a first instance of the event e₁ occurs at time 20, a first instance of the event e₂ occurs at time 40, a first instance of the event e₃ occurs at time 60, a first instance of the event e₄ occurs at time 80, and a first instance of event e₅ occurs at time 160. Each event then repeats according to the respective adjusted period shown in table 1.

As another example, a set of events (e₀, e₁, e₂, e₃, e₄) may have respective periods of (100, 150, 200, 300, 700). In this example, the periods are in units of milliseconds. Calculating the adjusted period as described above results in adjusted periods of (100,100,200, 200, 400). Continuing as described above, the starting times for these events would be (0, 25, 50, 75, 150). FIG. 2 depicts an example schedule 200 associated with the set of events (e₀, e₁, e₂, e₃, e₄). In some examples, each event can be reading from a particular respective data channel.

As illustrated in FIGS. 1-2, each event occurs based upon its adjusted period. For example, in the schedule 200, the events e₀ and e₁ repeat every 100 ms and the events e₂ and e₃ repeat every 200 ms. In this example, the original period is the maximum time that a value is available to be read. In other words, the original period may indicate the maximum time between reads of a particular data channel. Accordingly, reading a value more times than original period does not result in any missed requirements based on the original period. FIG. 2 also provides a visual indication of smoothing out the data access over a period of time. For example, if events e₀ and e₃ occurred near one another, then data access would have a consistent peak every 200 ms when both events occurred at nearly the same time. As shown in FIG. 2, the events e₀ and e₃ are separated by at least pₘᵢₙ/4 or 25 milliseconds.

While the above examples describe how to calculate starting times for various events, the starting times for one or more events may be altered. In one example, the starting time for any may be modified by adding or subtracting a factor of at most pₘᵢₙ/x₀ to each event. In practical terms, the times that can be added or subtracted may be pₘᵢₙ/x₀−eventₘₐₓ where eventₘₐₓ is the maximum amount of time associated with completing an event. Other examples may also include event_{avg} or eventₘᵢₙ. In some examples, the factor may range from 0 to pₘᵢₙ/x₀. In some examples, this factor may be added to one event, two events, three events, etc. In some examples, this factor may be added to all of the events. In one example, the factor may be a random number selected to be in the appropriate range. In another example, the factor may be based on the amount of time an event needs to complete. For example, an event may involve reading a sensor that is very fast. Another event may involve accessing data that has a longer delay. The factor selected for each event may be determined based on the delay or lack of any delay. For example, a slow event can have their start time moved back by subtracting a factor from an associated start time. Fast events may have their start time unchanged or moved up. Moving a start time can allow the earlier event to have additional time to complete, thus smoothing out the processor utilization. In one example, events in each order can be sorted by how quickly they are expected to finish. The fastest events may be assigned time slots first. In this example, the slowest event from one order can precede the fastest event in the next order for at least some time slots. In another example, the slowest and fastest events in the lowest order may be sorted, such that the slowest event precedes the fastest event. As the events are in the same order, the slowest event may start up to pₘᵢₙ/x₀ earlier and the fastest event may be delayed up to pₘᵢₙ/x₀. In this way, the slowest event can be given the most amount of time to complete while still allowing all events to be scheduled.

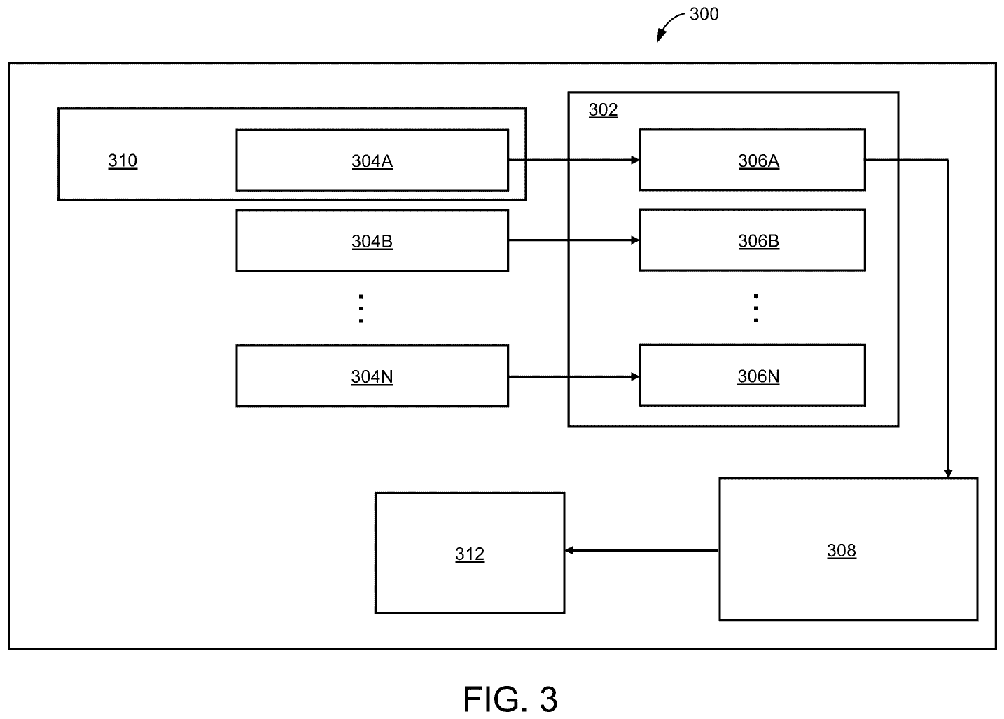

FIG. 3 depicts an example system 300 that can be associated with a set of events. The system 300 comprises a memory 302 and a plurality of data sources 304A-304N. The plurality of data sources 304A-304N is configured to provide a plurality of data units 306A-306N, which can be stored in the memory 302. The system 300 also comprises a processor 308.

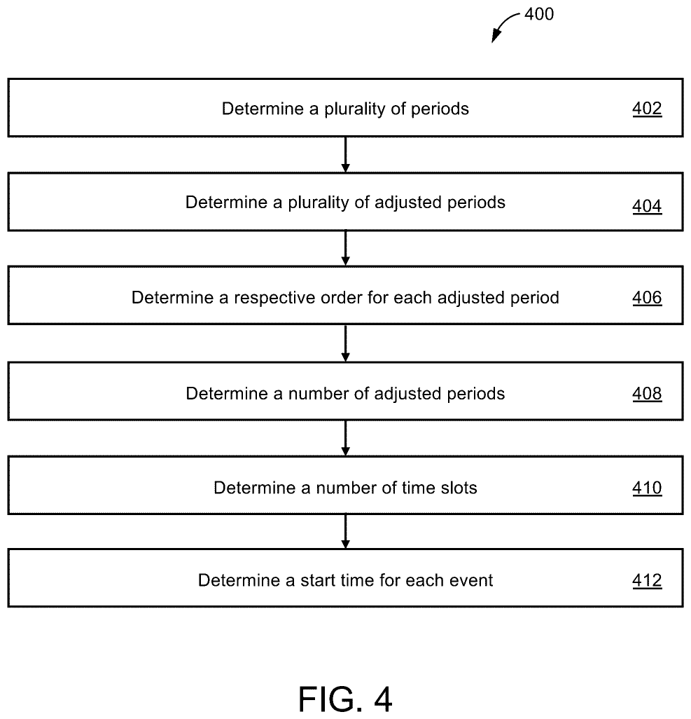

In some examples, each of the plurality of data units 306A-306N can be associated with a respective event. In some implementations, a processor 308 can be configured to compute or calculate quantities associated with each event to determine a schedule of start times for the events. FIG. 4 depicts an example flow chart of steps that a processor can be configured to complete. A processor can be configured to determine 402 a plurality of periods, where each period of the plurality of periods is associated with a respective event. The processor can then determine 404 a plurality of adjusted periods, where each period of the plurality of periods is associated with a respective adjusted period of the plurality of adjusted periods. The processor can then determine 406 a respective order for each adjusted period of the plurality of adjusted periods and determine 408 a number of adjusted periods in each of the orders. In some implementations, the processor can also be configured to determine 410 a number of time slots for a lowest order of adjusted periods based on the number of adjusted periods within each of the orders, and determine 412 a start time for each event based at least in part on the order of the event and the number of time slots for the lowest order of adjusted periods.

In some implementations, the system 300 can further comprise a first component 310 that is associated with a first data source 304A and a second component 312 that is configured to be controlled by the processor 308. In some examples, a processor 308 can be configured to access a data unit 306A associated with the first data source 304A at a determined start time and control the second component 312 based at least in part on the accessed data unit 306A.

As a specific example of how scheduling may work, an embedded system may include one or more circuit boards. In some examples, an atomic clock can be considered an embedded system. Some atomic clocks can comprise various data channels. The various data channels may provide various data about components of the atomic clock. Data from one component may impact the use of another component. For example, each circuit board may have various components that produce data. As an example, a system can comprise a temperature sensor that provides the temperature of a component. As another example, a component itself may provide access to data that indicates its temperature. In some examples, an embedded system can comprise one or more components that are configured to be controlled by the embedded system based at least in part on data accessed from a component. Without intending to be limiting, some examples of controllable components include mirrors, rotators, electro-optical devices, or thermo-optical devices. Some controllable components can be tuned to optimize performance of an embedded system. As one specific example, a diode temperature of laser may be monitored on a schedule. The embedded system or a processor thereof may use the diode temperature to determine if the laser is thermalized and may then proceed with tuning of other components.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A system comprising:
a memory configured to store a plurality of data units;
a plurality of data sources, where each data source is configured to provide a respective data unit; and
a processor configured to:
determine a plurality of periods where each period of the plurality of periods is associated with a respective event and each event is associated with a different respective data source of the plurality of data sources providing a data unit,
determine a plurality of adjusted periods, where each period of the plurality of periods is associated with a respective adjusted period of the plurality of adjusted periods,
determine a respective order for each adjusted period of the plurality of adjusted periods,
determine a number of adjusted periods associated with each of the orders,
determine a number of time slots for a lowest order of adjusted periods based on the number of adjusted periods within each of the orders, and
determine a start time for each event based on the order of the event and the number of time slots for the lowest order of adjusted periods.

2. The system of claim 1, wherein to determine the plurality of adjusted periods the processor is further configured to:
determine the minimum period of the plurality of periods as pₘᵢₙ, and
for each period of the plurality of periods calculate the corresponding adjusted period as pₘᵢₙ*2^{floor(log}^{₂}^{(period/p}^{ₘᵢₙ}⁾⁾.

3. The system of claim 2, wherein to determine the respective order for each adjusted period of the plurality of adjusted periods the processor is further configured to:
sort the plurality of adjusted periods, and
assign a unique order for each adjusted period of a same value, such that the plurality of adjusted periods have a highest order.

4. The system of claim 3, wherein to determine the number of time slots for the lowest order of adjusted periods the processor is further configured to calculate a summation
$$⌈ {\sum }_{i} \frac{{n}_{i}}{{2}^{i}} ⌉ ,$$
where i is equal to the order, and nᵢ is equal to a number of events in the order.

5. The system of claim 3, wherein to determine the number of time slots for the lowest order of adjusted periods the processor is further configured to:
determine a number of time slots for the highest order of adjusted periods as the number of adjusted periods in the highest order, and
for each remaining order, determine a number of time slots for a current order as the number of adjusted periods in the current order plus a ceiling of the number of time slots of an immediately previous order divided by two, wherein the number of time slots is equal to the number of time slots for the lowest order.

6. The system of claim 1, wherein to determine the start time for each event based on the order of the event the processor is further configured to:
calculate pₘᵢₙ/(the number of time slots) to create time slots of the lowest order, and
assign each event associated with the lowest order of adjusted periods to one of the time slots of the lowest order as the start time.

7. The system of claim 6, wherein to determine the start time for each event based on the order of the event the processor is further configured to:
for each remaining time slots of the lowest order, add pₘᵢₙ*2ⁱ⁻¹ to create time slots of a next order, where i is the order, and
assign each event associated with adjusted periods of the next order to one of the time slots of the next order as the start time.

8. The system of claim 1, wherein to determine the start time for each event based on the order of the event, the processor is further configured to either add an adjustment factor to or subtract an adjustment factor from least one start time.

9. The system of claim 8, wherein the adjustment factor is within the range of plus or minus: pₘᵢₙ/(the number of time slots for the lowest order of adjusted periods).

10. The system of claim 8, wherein the adjustment factor is based at least in part on a completion time associated with an event.

11. The system of claim 1, wherein the system further comprises:
a first component associated with a data unit provided by a first data source of the plurality of data sources; and
a second component configured to be controlled by the processor;
wherein the processor is further configured to:
access the data unit of the first component at the determined start time, and
control the second component based on the accessed data unit of the first component.

12. The system of claim 11, wherein to determine the number of time slots for the lowest order of adjusted periods the processor is further configured to calculate
$$⌈ {\sum }_{i} \frac{{n}_{i}}{{2}^{i}} ⌉ ,$$
where i is equal to the order, and nᵢ is equal to a number of events in the order.

13. The system of claim 1, wherein each event is associated with the processor accessing a respective data unit.

14. The system of claim 13, wherein the processor accesses the data unit at the start time associated with the event or at a time that is the sum of the start time and an integer multiple of the adjusted period associated with the event.

15. The system of claim 1, wherein the system further comprises
a first component configured to be controlled by the processor;
wherein a first data source of the plurality of data sources is configured to provide a data unit for each event of a plurality of events and the processor is configured to control the first component based at least in part on each data unit.

16. The system of claim 15, wherein a first event of the plurality of events is the determined start time and each subsequent event of the plurality of events is a sum of the determined start time and an integer multiple of an associated adjusted period.

17. A method for scheduling event start times for a system comprising a plurality of data sources, where each data source of the plurality of data sources is configured to provide a respective data unit, the method comprising:
determining a plurality of periods, where each period of the plurality of periods is associated with a respective event and each event is associated with a respective data unit of a data source;
determining a plurality of adjusted periods, wherein each period of the plurality of periods is associated with a respective adjusted period of the plurality of adjusted periods;
determining a respective order for each adjusted period of the plurality of adjusted periods;
determining a respective number of adjusted periods associated with each order;
determining a number of time slots for a lowest order of adjusted periods based at least in part on the respective number of adjusted periods within each order; and
determining an event start time for each event based at least in part on (1) the order of the event and (2) the number of time slots for the lowest order of adjusted periods.
